(19) United States
(12) Patent Application Publication
(10) Pub. No.: US 2002/0166272 A1
(43) Pub. Date: Nov. 14, 2002

(54) House address number sign

(76) Inventor: Robert Earl Gaymon, Baltimore, MD (US)

Correspondence Address: ROBERT EARL GAYMON SR., 3123 Ripple Road, Baltimore, MD, 21244, US

(21) Appl. No.: 10/150,841

(22) Filed: May 17, 2002

Related U.S. Application Data
(63) Continuation-in-part of application No. 09/707,483, filed on Nov. 7, 2000.

(51) Int. Cl. G09F 13/04

(52) U.S. Cl. 40/575; 40/574

(57) ABSTRACT

An illuminated address display comprising (1) a housing having the following surfaces, a top, a slanted back, a front with a beveled rectangular opening, a transparent front panel, a removable top, a right, and a left side, also a bottom (2) an interior partition to divide viewing area and wiring section, (3) a pair of slots, of which are attached to the left side interior surface, and left side of interior partition surface with a slot across the bottom interior which joins said slots behind front interior surface, and complementarity aligned so that the slots are parallel to each other, (4) a transparent front panel having two side edges and bottom each of which slides into the first set of slots, and rests in the bottom slot. These slots hold the panel behind, and in approximate parallel alignment to the front interior surface, (5) a second pair of slots, of which are attached to the left side interior surface, and left side of interior partition surface with a slot across the bottom interior which joins said second slots, and complementarity aligned so that the slots are parallel to each other, (6) a transparent mounting panel having two side edges each of which slides into the second set of slots to hold the panel behind and in an approximate parallel alignment to the first set of slots, and rests in the bottom interior slot, this panel has indicia mounted on the front surface with spacing between the first and second set of slots for indicia thickness, (6) a light mounting bracket having two ends and a hollow center each of which sets in slots on the left side interior surface and left side of interior partition behind second set of slots, (7) a light source mounted to the interior of the mounting bracket to provide light that reflexes off the back interior white surface of the housing to back light the address indicia, (8) a photo cell sensor mounted to the housings upper right front surface, (9) an electrical power source supplying power to the light and sensor for automatically turning on and off the light source when the illumination level of the sensor falls below and above, respectively, the specified illumination level, and wherein the housings' sides are configured so as to orient the housing transparent panels so that they are spaced apart and perpendicular with respect to the housing front inner surface so as to optimize the address indicia's visibility during daylight and night time hours.

### BACKGROUND OF THE INVENTION

1. Field of the Invention

The present invention generally relates to illumination devices. More particularly, this invention relates to devices for illuminating a house address sign, which is mounted near the house's entrance, so as to facilitate the sign's observation at night as well as during daylight hours and, from a greater distance.

2. Description of the Related Art

Identifying houses by their street number during night-time hours have been long-standing problems. House numbers and the likes are generally attached on or in the vicinity of the front door of a house, but few of these numbers are illuminated so as to facilitate their observation at night.

Many U.S. patents have been directed to providing devices for illuminating house-identifying information. In some illuminated signs such as neon signs or those using fiber optics, the light source is carried in and made a part of the letters, numbers or other characters forming the message on the sign. The letters, numbers and other charters are generally exposed and are not readily changeable. See U.S. Pat. Nos. 4,854,062 and 5,408,773.

A second type of illuminated sign utilizes translucent front materials, opaque numbering and a light behind the numbering to illuminate the numbering during the day or night. The systems often require multiple, diverse manufacturing parts and fabrication steps. See U.S. Pat. Nos. 3,590,507, 4,254,457, 4,373,284, 4,807,378, 4,848,017, 4,951,406, and 5,048,210.

Additionally, many types of illumination signs have disclosed that provide other special features, such as: lighting an entrance near the sign (U.S. Pat. No. 5,911,524), an emergency signal system (U.S. Pat. No. 4,611,265), an adjoining display shelf (U.S. Pat. No. 5,305,979), and remote control or photo-cell operation (U.S. Pat. No. 5,649,378).

Despite this prior art, the percentage of residential buildings displaying such signs continue to appear to be relatively small. Thus, there continues to be a need for a device for illuminating house-identifying information which is less complex to manufacture, less expensive to own and operate, and more aesthetically appealing.

### SUMMARY OF THE INVENTION

The present invention is generally directed to satisfying the needs set forth above and the problems identified in the prior arts. The problem of illuminating house-identifying information inexpensively and in an aesthetically appealing manner is resolved by the present invention.

In accordance with one preferred embodiment of the present invention, the need can be satisfied by providing an illuminated address display comprising (1) a housing having the following surfaces, a top, a slanted back, a front with a beveled rectangular opening, a transparent front panel, a removable top, a right, and a left side, also a bottom (2) an interior partition to divide viewing area and wiring section, (3) a pair of slots, of which are attached to the left side interior surface, and left side of interior partition surface with a slot across the bottom interior which joins said slots behind front interior surface, and complementarity aligned so that the slots are parallel to each other, (4) a transparent front panel having two side edges and bottom each of which slides into the first set of slots, and rests in the bottom slot. These slots hold the panel behind, and in approximate parallel alignment to the front interior surface, (5)a second pair of slots, of which are attached to the left side interior surface, and left side of interior partition surface with a slot across the bottom interior which joins said second slots, and complementarity aligned so that the slots are parallel to each other, (6) a transparent mounting panel having two side edges each of which slides into the second set of slots to hold the panel behind and in an approximate parallel alignment to the first set of slots, and rests in the bottom interior slot, this panel has indicia mounted on the front surface with spacing between the first and second set of slots for indicia thickness, (6) a light mounting bracket having two ends and a hollow center each of which sets in slots on the left side interior surface and left side of interior partition behind second set of slots, (7) a light source mounted to the interior of the mounting bracket to provide light that reflexes off the back interior white surface of the housing to back light the address indicia, (8) a photo cell sensor mounted to the housings upper right front surface, (9) an electrical power source supplying power to the light and sensor for automatically turning on and off the light source when the illumination level of the sensor falls below and above, respectively, the specified illumination level, and wherein the housings' sides are configured so as to orient the housing transparent panels so that they are spaced apart and perpendicular with respect to the housing front inner surface so as to optimize the address indicia's visibility during daylight and night time hours.

This new and improved illuminated address display is seen to achieve its objective of being less complex to manufacture, less expensive to own and operate, and more aesthetically appealing than competitive products.

Other objects and advantages of this invention will become readily apparent as the invention is better understood by references to the accompanying drawings, and the detailed description that follows.

### BRIEF DESCRIPTION OF THE DRAWINGS

FIG. 1 is a perspective view showing House Address Number Sign, one embodiment of the present invention complete with indicia shadowing, and a white background to enhance shadowing, and reflective ability.

FIG. 2 is a perspective view showing the embodiment of FIG. 1 housing with its top surface and, power supply compartment cover raised and all elements removed leaving only photo cell sensor.

FIG. 3 is a perspective view showing the embodiment of FIG. 2 with all associated electrical parts viewed. Light bracket lifted to show supports on left interior surface and, left side of interior partition surface with light removed from bracket interior and electrical connections.

FIG. 3a a cutaway view of the right side of housing showing electrical compartment interior with electrical connections, light, photo cell, and, power source.

FIG. 3b an exploded top right view of electrical compartment showing electrical compartment interior with electrical connections to light, photo cell and power source.

FIG. 4 a perspective view showing the embodiment of FIG. 2 with its transparent panel, and attached indicia in place raised to show its designated slots.

FIG. 5 a perspective view showing the embodiment of FIG. 2 with the transparent front panel in place and raised to show its designated slots.

FIG. 6 a Cross cut section of left side view of housing in a vertical position to show designed slanted back relative position of interior members.

FIG. 6a a left side view of housing and with designed slanted back positioned as it would be attached to the exterior of a house or building.

FIG. 7 a perspective view showing the embodiment of FIG. 1 attached to exterior siding of a house or building during daylight hours with shadowing effect.

### DESCRIPTION OF THE PREFERRED EMBODIMENT

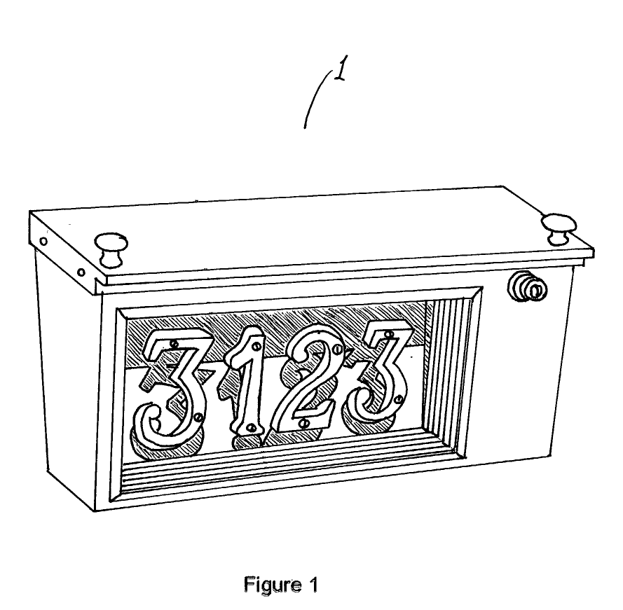

Referring now to the drawings wherein are shown preferred embodiments and, wherein like reference numerals designate like elements throughout, there is shown in FIG.1 a perspective view during daylight hours, one embodiment of the present invention.

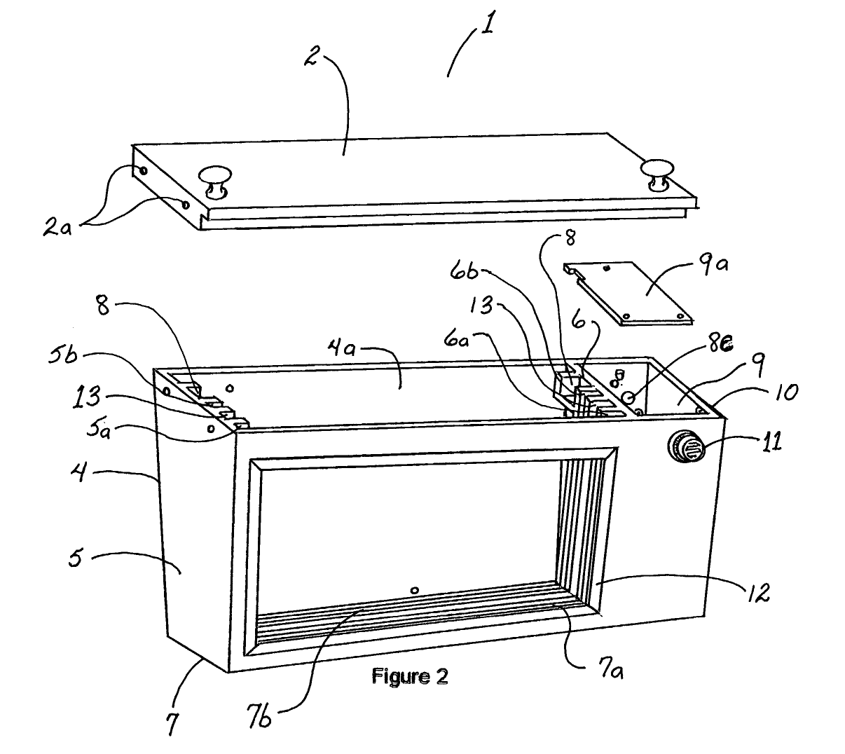

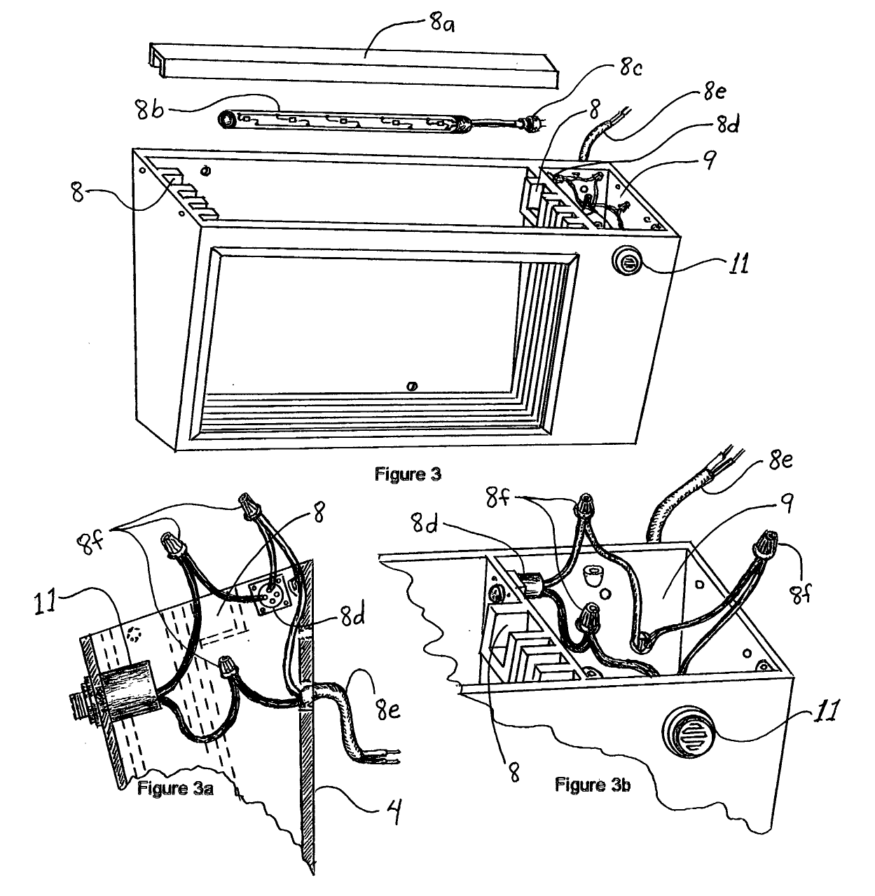

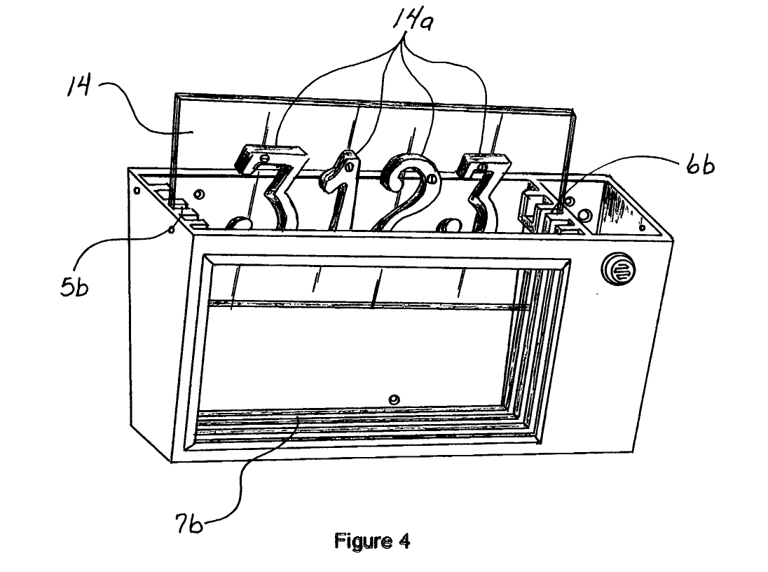

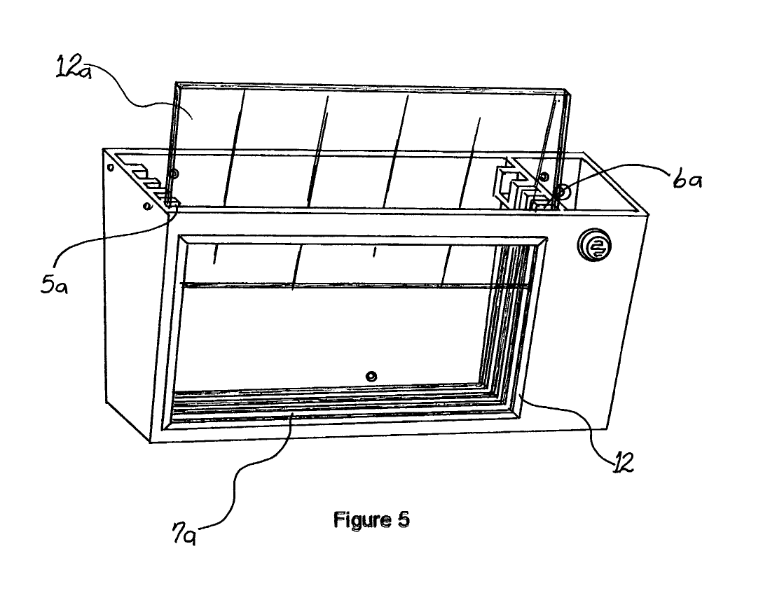

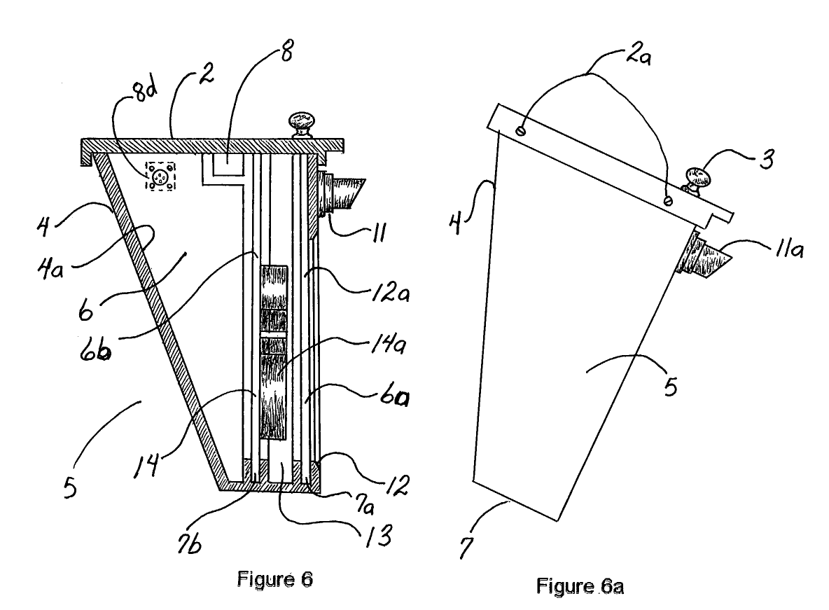

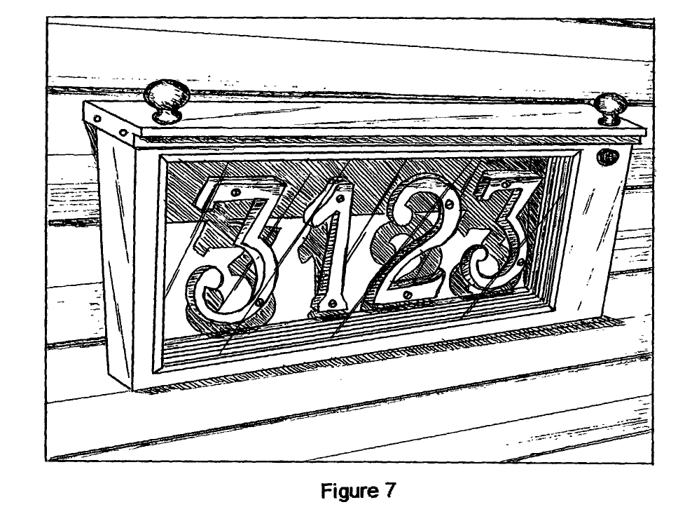

The various elements of this embodiment are better shown in each of the following drawings. These drawings will show the present invention with its top surface, and all other internal elements removed from housing's interior for clarity. As the drawings progress the elements will be shown in or above their designated positions. FIG. 2 shows an empty housing 1, with its top surface element 2, a front with rectangular beveled opening 12, left side exterior 5, slanted back 4, with white surface interior 4a, interior partition 6, right side exterior 10, wiring compartment interior 9, wiring compartment cover 9a, bottom exterior 7, sensor 11, front transparent panel slots, left side interior 5a, left side of interior partition 6a, bottom interior slot 7a, interior spacing for indicia numbers 13, transparent panel, and, indicia slots, left side interior 5b, left side of interior partition 6b, bottom interior slot 7b, light bracket slots 8, top mounting holes 2a, power supply opening 8e, FIG. 3 shows light, bracket 8a, raised from bracket slots 8, also light with five 1.5 watt's incandescent lamps enclosed in plastic tube 8b, which fits inside said bracket, a 2 pin connection plug 8c, wired to light has been disconnected from receptacle 8d (see FIG. 3b), wiring and power supply 8e, connected with wire nuts 8f, a sensor 11, wired to said receptacle, and power supply. Said wire nuts hold the three wire connections and are then pushed down into said wiring compartment interior (see FIG. 3), wiring compartment cover is than replaced with screws (not shown) (see FIG. 2). FIG. 3a and, FIG. 3b shows a right side crosssection cutaway and top right exploded view respectively of wiring compartment for clarity. FIG. 4 display's transparent panel 14, and affixed indicia 14a, attached to front of said transparent panel and raised in its designated slots, in the left side interior 5b, and left side of interior partition 6b, the panel has been removed from its bottom slot 7b, FIG. 5 display's a front transparent panel 12a, raised in its designated slots in the left side interior 5a, and left side of interior partition 6a, this panel has been removed from its bottom slot 7a, when seated in bottom slot it encloses the housing front rectangular opening 2. FIG. 6 show a cross cut of left side of housing view exposing left side of interior partition of housing in the vertical position to better show slots positioning, top 2, light bracket mount 8, connector 8d, slanted back surface 4, high gloss white interior 4a, left side of interior partition 6, left side interior partition slot 6b, transparent panel for indicia 14, bottom slot 7b, interior spacing for indicia numbers 13, bottom slot 7a, front with rectangular beveled opening 12, left side interior partition slot 6a, indicia 14a, front transparent panel 12a, sensor 11a. FIG. 6a shows a left side view 5, with brass knob 3, top retaining screws 2a, a sensor lens cover 11a, bottom exterior 7, of housing in the position it would be mounted to a house or building, the slanted back surface 4, when attached to said building changes the position of the house address number sign. The repositioned viewing angle reduces sun glare during day light hours and enhances the house signs appearance. FIG. 7 shows a complete embodiment of FIG. 1 the present invention mounted on the side of a house with siding, and the distinctive shadowing that occurs behind the indicia. This distinctiveness is further enhanced when the interior of the housing's back surface is white to maximize visibility of the address indicia. With shadowing behind the indicia during sunlit days, the shadowing is enhanced by the indicia being a high polished brass with the sun light striking their surfaces for a light and dark contrast.

Although the foregoing disclosure relates to preferred embodiments of the invention, it is understood that these details have been given for the purposes of clarification only. Various changes and modifications will be apparent, to one having ordinary skill in the art, without departing from the spirit and scope of the invention as hereinafter set forth in the claims.

Drawing Number Description list

| | |
|---|---|
| Housing | 1 |
| Top | 2 |
| Top Hold Down Screws | 2a |
| Brass knobs | 3 |
| Slanted Back | 4 |
| Slanted Back High Gloss White Interior | 4a |
| Left Side | 5 |
| Left Side interior Slot.(front panel) | 5a |
| Left Side interior Slot.(Indicia panel) | 5b |
| Partition | 6 |
| Partition left side interior (front panel) | 6a |
| Partition left side interior (Indicia panel) | 6b |
| Bottom | 7 |
| Bottom Interior (front panel) | 7a |
| Bottom (indicia panel) | 7b |
| Light Bracket Slots | 8 |
| Light Bracket | 8a |
| Light Source | 8b |
| Light Connection | 8c |
| Light Receptacle | 8d |
| Power Source | 8e |
| Wire Nuts | 8f |
| Wiring Compartment | 9 |
| Wiring Compartment cover | 9 |
| Right Side | 10 |
| Sensor | 11 |
| Sensor Lens Cover | 11a |
| Front w/Beveled rectangular opening | 12 |
| Transparent Front Panel | 12a |
| Spacing for Indicia (thickness) | 13 |
| Transparent Indicia Panel | 14 |
| Indicia | 14a |
| Indicia Shadowing | 14b |

I claim:

1. An illuminated address display, said address comprising:
a housing having the following surfaces, a top, a slanted back, a front with a rectangular opening and beveled edges, a transparent front panel, a removable top, a right side, and a left side, also a bottom.
a partition
a front pair of slots,
a transparent front panel
a space between slots
a second pair of slots,
a transparent panel, with address indicia's
a separate wiring compartment
a light source
a photo cell sensor
an electrical power source

2. An illuminated address display as recited in claim 1, a partition to separate the left and right side interior to create a compartment to contain the wiring and separate the viewing area from said wiring and power connections, partition also serves as a support wall for slots. and said panels.

3. An illuminated address display as recited in claim 1, the first set of slots, which are molded to the left side interior, and left side of partition interior, and joins across the bottom interior which joins said slots, and complementarity aligned so that the slots are parallel to each other are part of front rectangular opening of front interior surface.

4. An illuminated address display as recited in claim 3, a transparent front panel having two side edges and bottom each of which slides into the first set of slots, and resting in the bottom slot. Note: this panel encloses housing form environment.

5. An illuminated address display as recited in claim 4, a spacing behind said slotted members created for address indicia dimension thickness,

6. An illuminated address display as recited in claim 1, a second pair of slots, of which are attached to the left side interior surface, and left side of interior partition surface with a slot across the bottom interior which joins said second slots, and complementarity aligned so that the slots are parallel to each other.

7. An illuminated address display as recited in claim 6, a transparent mounting panel having two side edges each of which slides into the second set of slots to hold the panel behind and in an approximate parallel alignment to the first set of slots, and resting in the bottom interior slot, this panel has indicia mounted on front surface.

8. An illuminated address display as recited in claim 6, a light mounting bracket having two ends each of which sets in slots on the left side interior surface, and left side of interior partition behind second set of slots. Bracket supports light tube as well as hide the light tube from view to eliminate viewing distractions and light glare.

9. An illuminated address display as recited in claim 8, a light source with five 1.5 watt incandescent lamps enclosed in a plastic tube, mounted within said mounting bracket to provide light that reflects off the housings high gloss white interior back surface and passes through said transparent indicia panel, and transparent front panel to create back lighting of said address indicia during night time hours.

10. An illuminated address display as recited in claim 8, wherein the inside of said back surface is slanted and, being a high gloss white to aid in back lighting and optical distinctiveness, also chosen to provide maximum reflectivity of said address indicia day or night.

11. An illuminated address display as recited in claim 5, wherein said address indicia being three dimensional in nature and having a specified thickness is spaced behind front transparent panel interior with spacing for indicia thickness this also enhances 3-D effect.

12. An illuminated address display as recited in claim 5, the angle at which the housing is made is relative to the design, it lowers the housings top surface to reduce sun glare during daylight hours, and repositions the House Address Number Sign to help give it a 3-D effect for easer viewing, and aesthetics once mounted to a house or building.

13. An illuminated address display recited in claim 10 the use of two transparent panels and high gloss white interior back surface enhance the back lighting at night, and indicia's shadowing during the day. The shadowing is the direct result of sunlight passing through both transparent panels, and striking the indicia's surface, and as a result creating a indicia shadowing on the high gloss white interior back surface.
